(19) United States
(12) Patent Application Publication
(10) Pub. No.: US 2009/0222278 A1
(43) Pub. Date: Sep. 3, 2009

(54) Interactive entrepreneur network and information system

(76) Inventors: Adrie Reinders, New York, NY (US); Roeland Reinders, Amsterdam (NL); Marion Freijsen, Putten (NL)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 12/072,778

(22) Filed: Feb. 28, 2008

(51) Int. Cl. G06Q 99/00

(52) U.S. Cl. 705/1

(57) ABSTRACT

A social networking system and method for entrepreneurs includes a primary forum offering a plurality of multimedia tools and a primary member registration means for registering a plurality of members for access within a primary community. Members include entrepreneur members, investor members and coach members. The primary forum provides access to hyperlinked content for retrieving business information and interacting and communicating among members. The system further comprises a plurality of satellite forums that are linked to, hosted and maintained by the primary forum. Each satellite forum includes the multimedia tools derived from the primary forum so that members on the satellite forum have access to the information on the primary forum. Satellite forums have their own unique URL and is linked to, hosted and maintained by the primary forum and act as meeting places for satellite groups and satellite communities. Each satellite forum allows groups of entrepreneur members to build their own satellite community, allowing them to have control over their own member database and content.

### BACKGROUND OF THE INVENTION

1. Field of the Invention

The present invention relates to a web-based social network and information sharing method and system for entrepreneurs; and more particularly, to a multimedia interface enabling entrepreneurs to exchange business information, obtain financing and market place opportunities, and seek expert advice over the World Wide Web through a primary forum having a plurality of satellite forums.

2. Description of the Prior Art

Entrepreneurs face many challenges when starting a business, and in maintaining success and reaching goals, often involving networking and search for capital for financing. Many entrepreneurs turn to the internet for information and opportunities. Several of the entrepreneur related systems are merely local in nature and fail to provide a global network for accessibility by businesses/individuals. Others fail to provide the ability for users to establish satellite forums fully linked to a main platform that allows users to customize their own content and set up a closed community. Still others fail to provide a social networking system and method offering a plethora of tools to assist entrepreneurs in achieving success.

Several social networking systems and methods have been provided for use over the Internet for sharing information and services, but these systems are not focused on needs of and do not provide tools for entrepreneurs. For example: U.S. Patent Application Publication No. 2002/0023018 to Kleinbaum discloses a method and system using a communication network, such as the Internet, to form a forum for sharing information services; U.S. Patent Application Publication No. 2002/0128905 to Gillman, et al. discloses a system and method for networking with persons online; U.S. Patent Application Publication No. 2005/0171832 to Hull, et al. discloses a method, apparatus, and system directed towards making a user's online portal information available to members of an online social network; U.S. Patent Application Publication No. 2005/0197846 to Pezaris, et al. discloses methods and systems for generating and using proximity thresholds in a social networking environment; U.S. Patent Application Publication No. 2006/0116896 to Fowler, et al. discloses a method and system to maintain published contact information; U.S. Patent Application Publication No. 2007/0169165 to Crull, et al. discloses systems and methods for online social networking; U.S. Patent Application Publication No. 2007/0250336 to Khoury discloses a social networking, and more specifically, to systems and methods for bridging an online space and an offline physical venue; U.S. Patent Application Publication No. 2008/0021870 to Birnbaum, et al. discloses a method of gathering information within a social network; U.S. Patent Application Publication No. 2008/0021958 to Foote discloses a real time messaging platform that allows people to communicate with each other over the Internet; and Foreign Publication No. KR2002063994 A to Kang discloses a system and a method for managing an electronic business card for exchange between individuals. These systems and methods do not provide an online forum uniquely designed to address challenges faced by entrepreneurs, including providing information relative to financing, customer building, and expert advice. Further, these system and methods do not provide a plurality of satellite forums that are a blueprint of the main site, capable of being built-upon and custom tailored for their business. Rather, many of the communication networks at best provide the ability to chat in a chat room/forum, or merely provide the ability to link to another's web site exiting the main site altogether.

Other systems and methods merely provide computer-implemented search or filtering methods and systems, including: U.S. Patent Application Publication No. 2007/0250483 to Blue, et al. discloses a computer-implemented method for executing a search in a social networking application; U.S. Patent Application Publication No. 2007/0250585 to Ly, et al. discloses a computer-implemented method for leveraging social networking information with a messaging client are disclosed; and U.S. Patent Application Publication No. 2008/0005072 to Meek, et al. discloses architecture that monitors interaction data (e.g., search queries, query results and click-through rates), and provides users with links to other users that fall into similar categories with respect to the foregoing monitored activities. These computer-implemented search systems and methods do not provide an online forum for entrepreneurs, but merely provide methods and systems that may be utilized for filtering and searching profile information. Additionally, these system and methods do not provide a satellite site that is a blueprint of the main site to an outside group or community enabling it to built-upon and custom tailored for the (business) needs of their own members.

Systems and methods for networking web addresses and linking groups have been provided, including that disclosed by U.S. Patent Application Publication No. 2007/0150603 to Crull, et al. which teaches social networking systems and processes including cross-domain functionality; and U.S. Patent Application Publication No. 2007/0220090 to Hall which teaches a method and system for providing groups, organizations, associations and their chapters the ability to recruit members online, network and communicate with group members online, network and communicate with other groups online. Networking systems and group networking models as these do not provide a system uniquely designed for entrepreneurs; specifically they do not provide a primary forum including a financial link, customer building link, and an expert entrepreneurial advice link for the members. As well, these networking systems do not provide an entrepreneurial based system that provides multiple satellite forums that are each a blueprint of the primary forum so that it allows other groups or communities to license an off-the-shelf technology which can be whitelabeled to custom tailor it for their specific group's unique character and allow such a group to maintain its own closed community, offering content for its members only.

Where methods and systems have been provided that are appointed for entrepreneurs, these systems and methods do not disclose a globalized networking forum that is made up of a primary or main forum from which satellite forums are offered to other groups/communities, allowing such groups or communities to individualize, build and address their online community. Moreover, these entrepreneur systems do not provide a financial link, customer building link, and an expert advice link for all of the members (both individual and the members via the satellites). For example: U.S. Patent Application Publication No. 2003/0101115 to Reddy discloses a method and system in a computer network for interactively supporting investment opportunities for investors and entrepreneurs; and Non-Patent Literature entitled “Global Entrepreneurs Network” found at www.biztoo.com discloses a social networking site for entrepreneurs worldwide that provides an online community where entrepreneurs can meet new business contacts, provides an online business marketplace and social business networking site where entrepreneurs can ask and get business advice from global entrepreneurs. Although advice and information sharing between entrepreneurs is provided, these systems do not provide an expert advice link for members wherein “experts” (or “coaches”) are selected from a group of renowned successful entrepreneurs to give unsurpassed, extremely valuable guidance and advice. Rather, any advice derived from the systems and methods currently utilized involves entrepreneurs, at any level, including beginners, novices, or the like, exchanging ideas and advice. Further, these systems do not provide separate satellite forums built upon a main forum for other outside groups/communities, instead the disclosed systems and methods provide links to other Web Sites (“Linked Sites”) that are not under the control of/maintained by or a blueprint extension of a primary site.

Notwithstanding the efforts of prior art workers, there remains a need in the art for a social networking system and method that focuses and specializes in concerns facing entrepreneurs, and that is truly global in nature, building communities in nations all over the world, such as in India, New Zealand, Finland, Europe and the United States. Further needed in the art is an entrepreneur social networking system and method providing a unique satellite structure which is a blueprint of the main entrepreneur forum and is maintained by the main forum that allows other groups to build their online community using this blueprint, allowing them to whitelabel the satellite (own URL, look-and-feel, colors, logos), have control over their own member database (i.e. who joins, what type of password etc) and content. Moreover, there is a need in the art for a globalized social networking system and method focusing on the needs of entrepreneurs that provides a search engine on its main site, structured to pick up information on the publicly available pages of each satellite and thus drive traffic thereto, thus leveraging knowledge of each satellite as well as the communal knowledgebase on the main website. Still further, there is needed an entrepreneur social networking system and method that utilizes a unique navigational tool comprising four distinct quadrants, including a business exchange, finance, market place and lounge section, that is prominently displayed on all pages navigated to on the site, that is provided as a widget so it can be loaded into other sites (as well as satellites), and used to immediately jump to the main site.

### SUMMARY OF THE INVENTION

The present invention provides a web-based network and information sharing method and system enabling entrepreneurs to exchange business information, obtain financing and market place opportunities, and seek expert advice over the World Wide Web through a primary forum having a plurality of satellite forums. The invention is implemented over the Web, an intranet, or other network system. Entrepreneurs interact with a server, or a plurality of servers, in client server mode, using a standard browser, such as Microsoft Explorer or Netscape Navigator. Each entrepreneur registers as a member and receives an identifying username and password. The system provides a social network that focuses and specializes on challenges facing entrepreneurs. The system is globalized, providing the ability build communities in nations all over the world, such as in India, New Zealand, Finland, Europe and the United States. The entrepreneur system and method provides a unique satellite structure which is a “blueprint” of the main entrepreneur forum and is maintained by the main forum and allows other groups to build their online community using this blueprint, allowing them to whitelabel the satellite (own URL, look-and-feel, colors, logos), have control over their own member database (i.e. who joins, what type of password etc) and control over the satellite forum's Content Management System.

The globalized platform provides a search engine on its main site or primary forum, structured to filter information on the publicly available pages of each satellite and thus drive traffic there too, thus leveraging knowledge of each satellite as well as the communal knowledgebase on the main website/primary forum. Further, the entrepreneurial based platform utilizes a unique navigational tool comprising four distinct quadrants, including a business exchange, finance, market place and lounge, that is prominently displayed on all pages navigated to on the site, that is provided as a widget so it can be loaded into other sites (satellites), and used to immediately link to the main site or primary forum.

The network interactive system and method for entrepreneurs is created for entrepreneurs by entrepreneurs, providing a unique platform structured so that entrepreneurs can network with other entrepreneurs. An online network is provided that generates practical advice from leading business entrepreneurs who have successfully started their own companies. Three key factors critical to businesses drive the network interactive system for entrepreneurs: (i) financing venues; (ii) cost saving venues; and (iii) business and client expansion venues. Fostering these key factors is enhanced by linking entrepreneurs directly to advisors (coaches), venture capitalists (VCs), investors and clients. In conjunction with the tools offered by the network interactive system and method for entrepreneurs is a team or group of highly successful entrepreneurs (“coach members”) who have come together to pool their extensive networks and their unequalled experience (used under the trade name the “E-Team”) to share with entrepreneurs, ranging from advice for starting a business to expanding business into new territories. Access to a global network offers global resources to entrepreneur members, investor members and coach members.

The network interactive system for entrepreneurs is uniquely structured with satellites, or mini-platforms that are a blueprint of the basic community functionality of the primary forum, but having a separate ID, URL and look-and-feel, that it is fully linked to the primary forum business host. The plurality of satellites is maintained by the system, but satellite owners can bring in their own content and determine log-in for their members (closed community). Businesses maintain a “yellow pages” for all added satellites and provide a search engine that searches not only in the primary platform, but also in the surrounding public pages of the satellites.

The network interactive system for entrepreneurs has several “quadrants” built-in, each offering additional functionality that will help entrepreneurs, including: (a) Finance Corner—link to VCs, Angel investors, Financial institutions to find funding; (b) Savings Corner—as a group members combined buying power to achieve savings on anything from gadgets, to flights, to hotels etc.; (c) Market Place—members can offer and search for new business, new clients, franchisees, distributors or even Board Members and furniture; and (c) The Lounge—the interactive place where members can interact, chat, email, and show video clips. Additional features of the system's website include features such as: (1) the site is entirely multi-media; (2) members can build their own applications on top of the existing platform; (3) members can widgetize some elements of the site; and (4) members can have alerts and messages sent to the member's email and/or mobile phone.

In a first embodiment, the social networking system for entrepreneurs comprises a primary forum offering a plurality of multimedia tools and a primary member registration means for registering a plurality of members for access within a primary community. Members include entrepreneur members, investor members and coach members. The primary forum provides access to hyperlinked content for retrieving business information and interacting and communicating among members. The system further comprises a plurality of satellite forums that are linked to, hosted and maintained by the primary forum. Each satellite forum includes the multimedia tools derived from the primary forum so that members on the satellite forum have access to the information on the primary forum. Satellites have their own unique URL and act as meeting places for satellite groups and satellite communities, such as a group of woman entrepreneurs in the United Kingdom, and wherein the multimedia tools derived from the primary forum are capable of being custom tailored to reflect the group's unique character.

In another embodiment, the social networking system for entrepreneurs comprises a primary forum offering a plurality of multimedia tools and a primary member registration means for registering a plurality of members for access within a primary community. Members comprise entrepreneur members, investor members and coach members. The primary forum enables members to access hyperlinked content for business information and interact and communicate with each other. The system further comprises a navigational tool having distinct quadrants linked to the content sections hyperlinked on said primary forum. The quadrants are prominently displayed on all pages navigated to within the primary forum. Further, the navigation tool is provided as a widget so it can be loaded into satellite forums and hyperlinked to the primary forum so that it can be utilized to immediately jump to the primary forum when a member on a satellite forum selects the given quadrant within the navigation tool.

A method for displaying business information to a plurality of entrepreneurs in a networked interactive system is provided comprising the steps of: (i) structuring a platform with a primary forum offering a plurality of multimedia tools and a primary member registration means for registering a plurality of members for access within a primary community, the members comprising entrepreneur members, investor members and coach members, the primary forum enabling the members to access hyperlinked content for business information and interact and communicate with each other; and (ii) further structuring the platform with a plurality of satellite forums with unique URLs being linked to, hosted and maintained by the primary forum and including the multimedia tools derived from the primary forum. These satellite forums act as meeting places for satellite groups and satellite communities, such as a group of women entrepreneurs in the United Kingdom for example. The multimedia tools derived from the primary forum are capable of being custom tailored to reflect the group's unique character and theme, including name branding and content. A satellite forum is a template of scaled down functionality of the primary forum (operating under the trademark E.Factor), a copy that is adapted to the owner's group nature and branded as such. It has its own URL (same as every website) but only one URL for the group. Optionally, a second layer may be built upon the system wherein a satellite forum can host multiple other satellites or sub-satellites. For example, a satellite forum for a group of entrepreneurial women could have its own sub-satellite fractionalizing the group to ethnic minority sub-group or the like, or in turn a sub-satellite could be provided for different countries, or regions.

### BRIEF DESCRIPTION OF THE DRAWINGS

The invention will be more fully understood and further advantages will become apparent when reference is had to the following detailed description and the accompanying drawings, in which

FIGS. 1a and 1b illustrate basic operation of the system platform, briefly showing the relationship of the primary forum in relation to satellite forums and the general system platform;

FIG. 2 is a flow chart overview showing basic operation of the platform of the entrepreneur system and method showing the collection of information, including Web pages, images, videos or other digital assets, hosted on one or several Web server(s) that is transferred to the primary forum (website) for displayed in a user's Web browser, showing Public Site/Non-Member/Member Not Logged In;

FIG. 3 is a flow chart overview showing basic operation of the platform of the entrepreneur system and method showing member access to myControl Room;

FIG. 4 is a sample introductory home page screen shot;

FIG. 5 is blow-up of an example of the dynamic chart reflecting global memberships taken in section X located on the introductory home page screen shot of FIG. 4a;

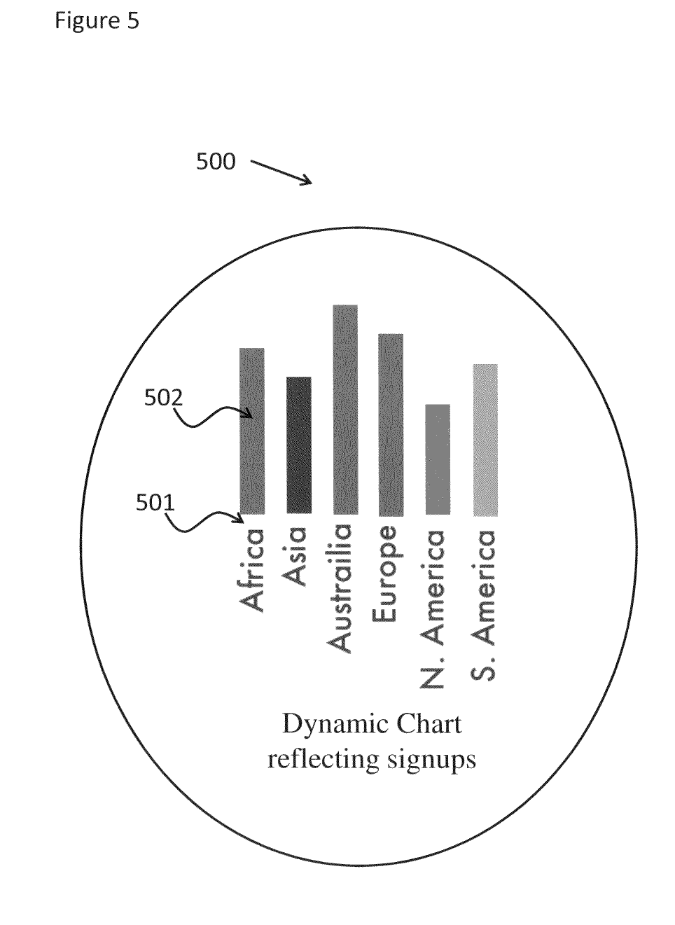

FIG. 6 is a sample BizXchange screen shot, where members can offer their services, find franchise distributors, channels, sell products, advertise and find board members or furniture;

FIG. 7 is a sample Lounge screen shot, providing an interactive social forum;

FIG. 8 is a sample Market Place screen shot, where members can combine buying power, obtain discounts on precuts and services and offers these at a discounted rate to members;

FIG. 9 is a sample Coach Search screen shot;

FIG. 10 is a sample Finance Corner screen shot where members can link with VCs, Investors, Angel Investors, etc. and can post a funding request;

FIG. 11 is a sample Invite Friends screen shot;

FIG. 12a is a sample screen shot of the My Control Room tools;

FIG. 12b is a sample screen shot of the My Control Room extended with design;

FIG. 13a is a sample Profile Bar minimum shot;

FIG. 13b is a sample Profile Bar Full shot;

FIG. 14 is a screen shot showing the MyMap tool;

FIG. 15a is a screen shot showing the sign up process/set up process step leading to Control Room;

FIG. 15b is a half screen shot from within Control Room, showing privacy settings;

FIG. 15c is a screen shot showing [my]ControlRoom upon signing on; and

FIG. 15d is a flow chart showing sign-up steps.

### DESCRIPTION OF THE PREFERRED EMBODIMENTS

The network interactive system for entrepreneurs herein (used under the trademark ‘E.Factor^{E} or “Entrepreneur Factor”) is a distinctive network created for entrepreneurs by entrepreneurs providing a unique platform structured so that entrepreneurs can network with one another. Entrepreneurs facing challenges can readily network and exchange knowledge and techniques to meet those challenges. The entrepreneur network system provides practical advice from leading business people who have overcome the trials of setting up their own companies.

Three key business concerns drive the network interactive system for entrepreneurs: (i) financing venues; (ii) cost saving venues; and (iii) business and client expansion venues. By linking entrepreneurs directly to advisors, venture capitalists (VCs), investors and clients, the network interactive system for entrepreneurs fosters these key factors thereby supporting businesses. In conjunction with the tools offered by entrepreneur network is a team or group of highly successful entrepreneurs (coach members) who have come together to pool their extensive networks and their unequalled experience (used under the trademark “E-Team”) to share with entrepreneurs, ranging from advice for starting a business to expanding business into new territories. The network interactive system has access to a global network and utilizes this global network to market the entrepreneur network and provide global resources to their member entrepreneurs.

The network interactive system for entrepreneurs is uniquely structured with satellites, or mini-[‘E.Factor] platforms or satellite forums that provide the basic community functionality having a separate ID, URL and look-and-feel, that it is fully linked to the interactive entrepreneur network system's primary home page/platform, which acts as the business host. These satellite forums are utilized by satellite groups to yield satellite communities where group members can have a closed, group member only forum. The primary platform maintains all the satellites forums and provides a blueprint of features offered by the primary forum, while still allowing satellite owners/groups to build upon the satellite with their own content and set log-in for their satellite group members, so that the satellite can be a closed community based on the member's own criteria.

On the interactive entrepreneur network a “yellow pages” for all added satellites is provided, as well as a search engine that searches not only in the primary forum and satellites but also in the surrounding public pages of the satellites. The interactive entrepreneur network has several “quadrants” or hyperlinked content sections built-in, each offering additional functionality that will help entrepreneurs, including: (a) Finance Corner—link to VCs, Angel investors, Financial institutions to find funding; (b) Savings Corner—as a group members combined buying power to achieve savings on anything from gadgets, to flights, to hotels etc.; (c) MarketPlace—members can offer and search for new business, new clients, franchisees, distributors or even Board Members and furniture; and (c) The Lounge—the interactive place where members can interact, chat, email, and show video clips. Additional features of the interactive entrepreneur network website include features such as: (1) the site is entirely multi-media; (2) members can build their own applications on top of the existing platform; (3) members can widgetize some elements of the site; and (4) members can have alerts and messages sent to the member's mobile phone.

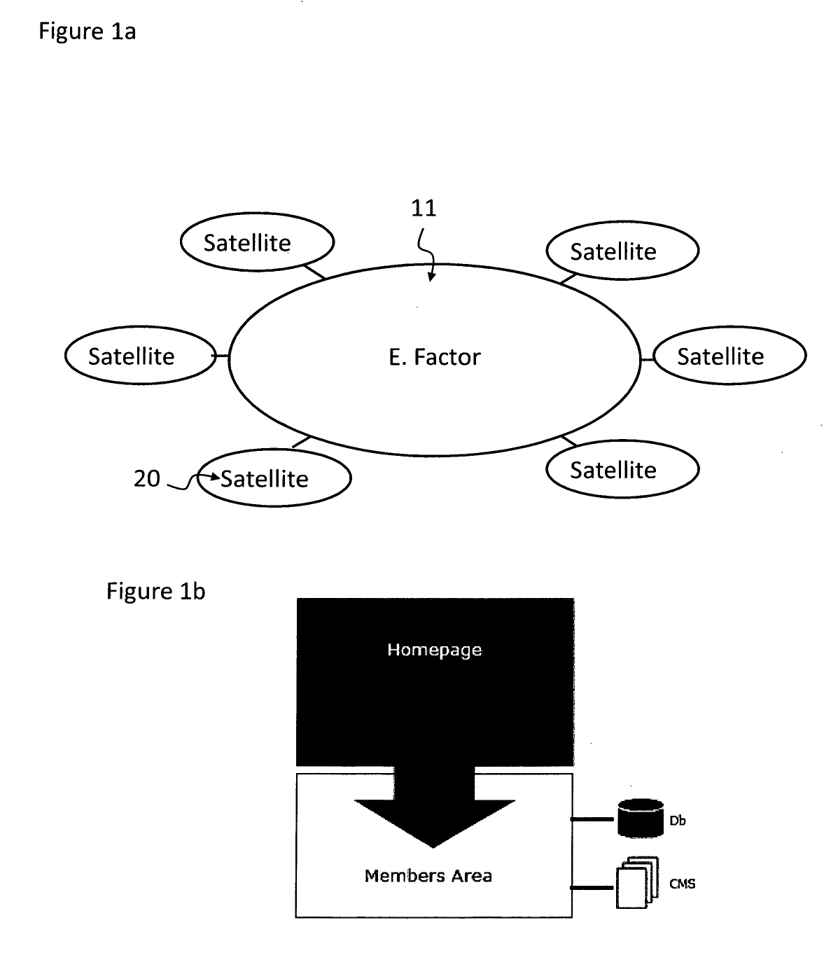

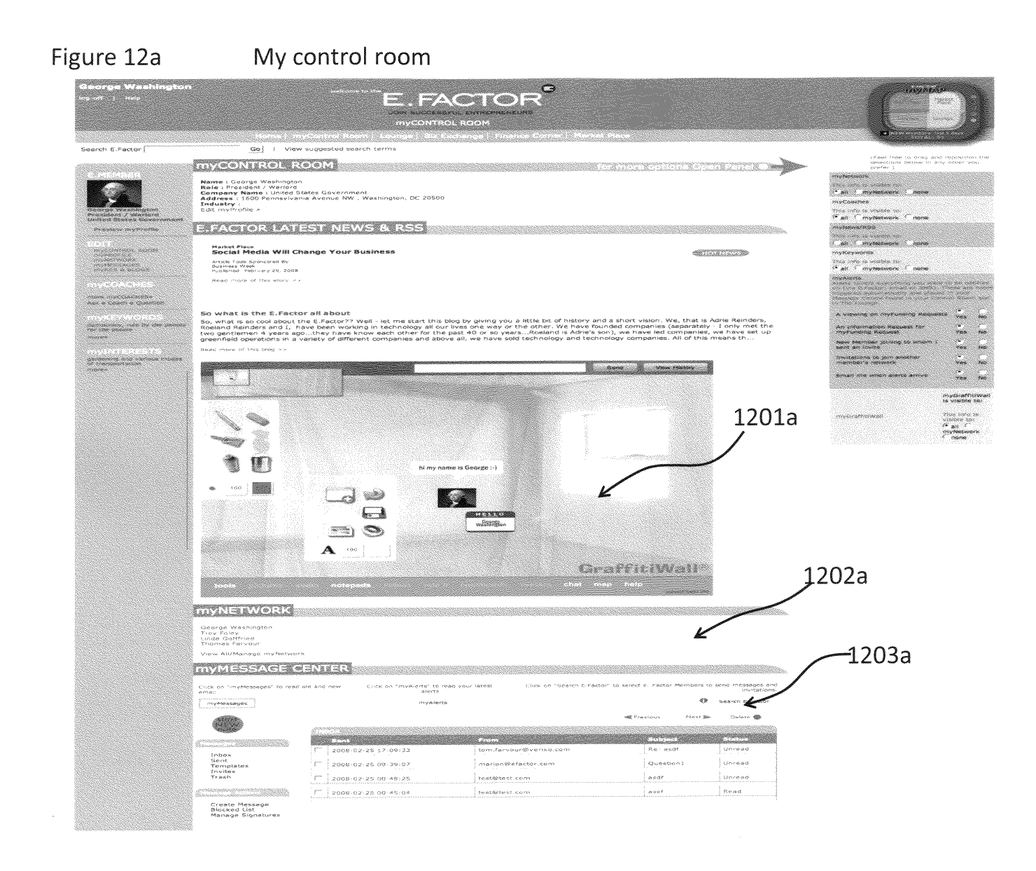

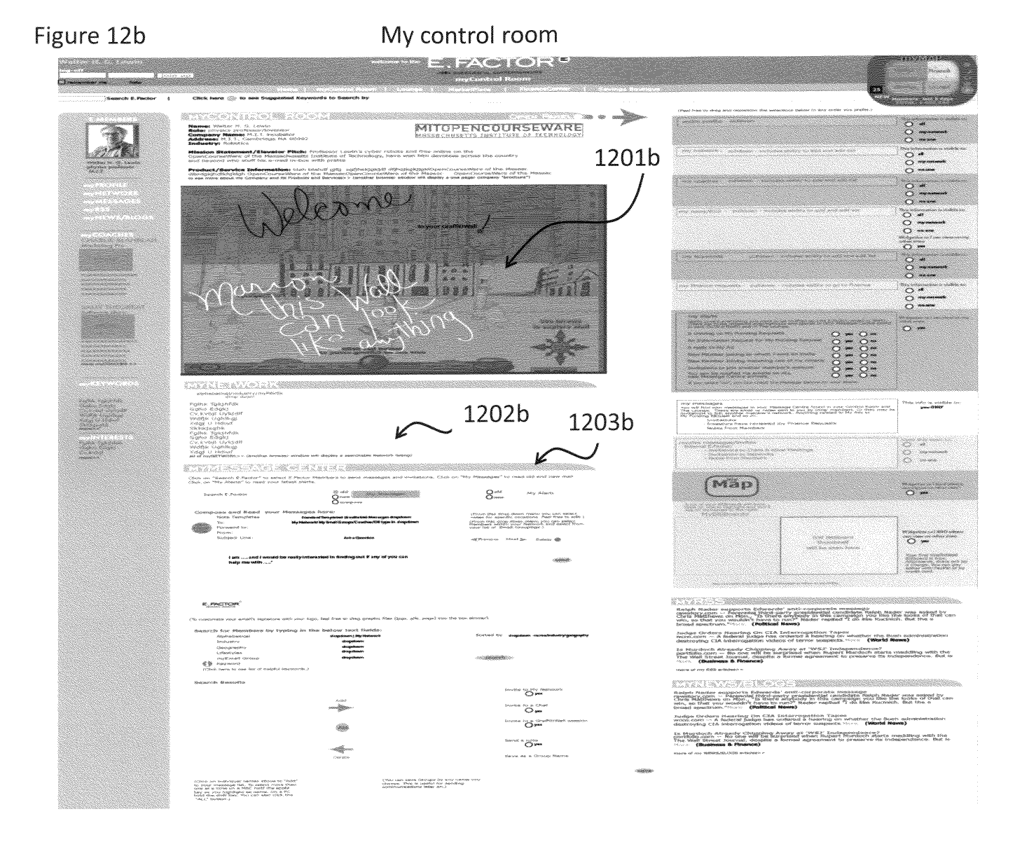

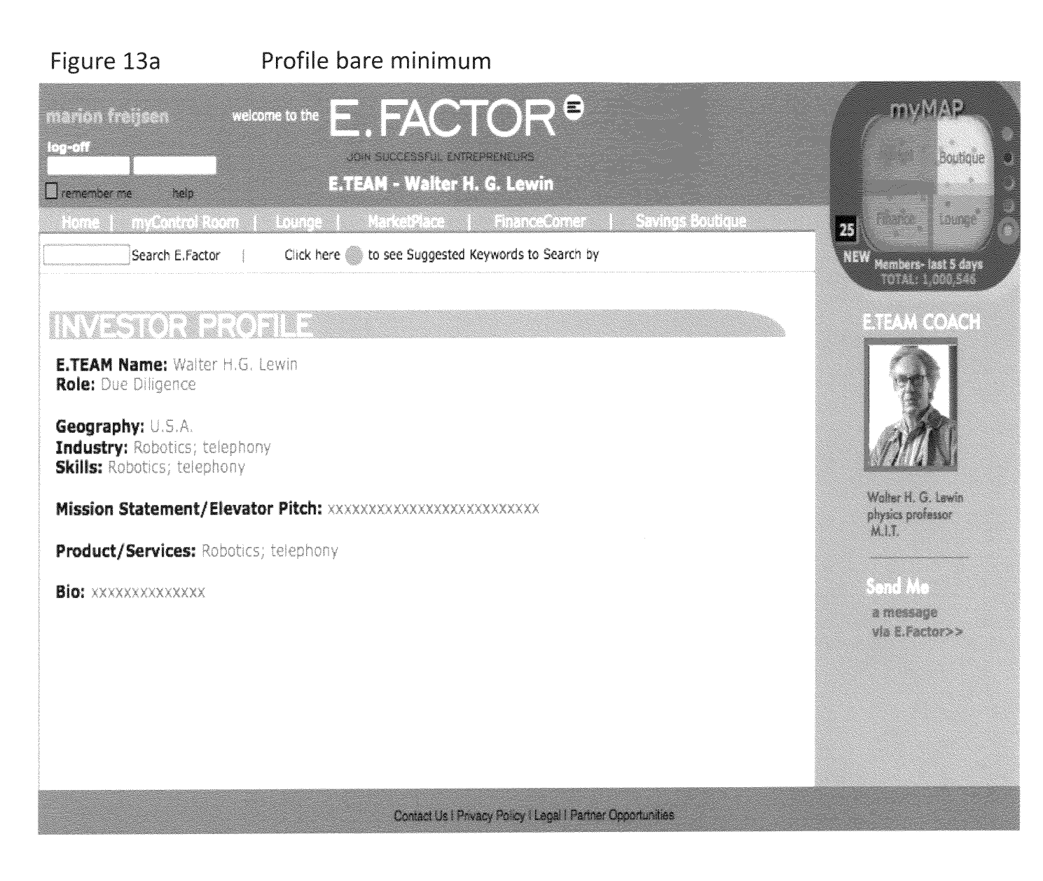

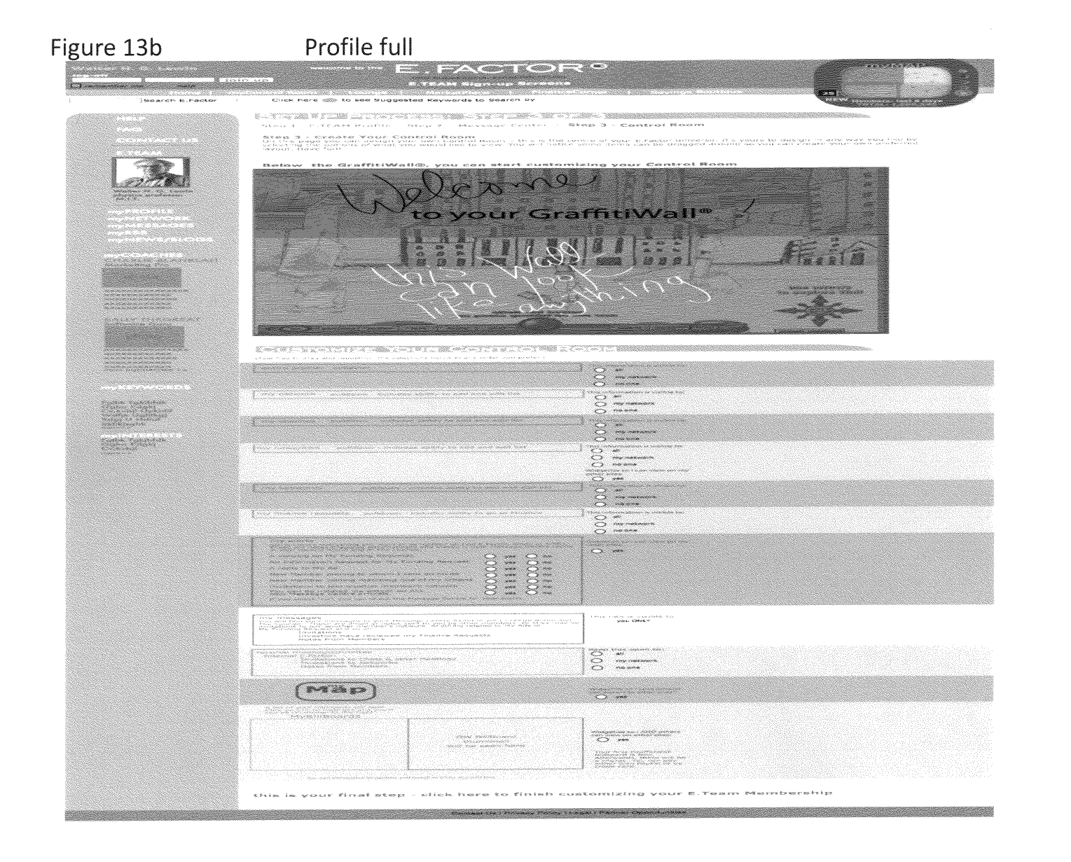

FIGS. 1a and 1b illustrate an overview of the basic operation of the platform, showing relationship of the primary forum and satellite forums. The interactive entrepreneur network's technical platform includes a multimedia embedded primary forum 11, built in such a way that other communities, satellite forums, indicated at 20, can benefit from the fully interactive primary forum 11 developed for the interactive entrepreneur network platform. Basically primary forum 11 consists of two parts: (i) a freely accessible homepage; and (ii) a members-only website. Primary forum 11 offers a plurality of multimedia tools, including a combination of text, audio, still images, animation, video, and interactivity content forms. Primary forum 11 includes primary member registration means for registering a plurality of members for access within a primary community on the primary forum 11 (via primary website). Members comprise entrepreneur members, investor members and coach members. Primary forum 11 enables members to access hyperlinked content for business information and interact and communicate with each other (discussed further infra). The plurality of satellite forums 20 are linked to, hosted and maintained by primary forum 11 and include the multimedia tools derived from the primary forum 11. Such tools include the navigational tool (discussed further regarding FIGS. 12 and 13, infra). Each satellite-forum 20 has a unique URL and groups interface with the multimedia tools to modify and build-upon the assigned satellite forum 20 to customize it and build their own satellite community, allowing them to have control over their own member database and content. These satellite forums act as meeting places for satellite groups and satellite communities, such as a group of women entrepreneurs in the United Kingdom. The multimedia tools derived from the primary forum are capable of being custom tailored to reflect the group's unique character and theme, including name branding and content. A satellite forum is a template of scaled down functionality of the primary forum (operating under the trademark E.Factor), a copy that is adapted to the owner's group nature and branded as such. It has its own URL (same as every website) but only one URL for the group. Optionally, a second layer may be built upon the system wherein a satellite forum can host multiple other satellites or sub-satellites. For example, a satellite forum for a group of entrepreneurial women could have its own sub-satellite fractionalizing the group to ethnic minority sub-group or the like, or in turn a sub-satellite could be provided for different countries, or regions.

The primary registration means of the primary forum 11 comprises profile data including business related data, personal interest data, and access preferences, wherein said profile data is accessible to different members based on each member's own access preferences. Each of the satellite forums 20 comprises a freely accessible satellite-homepage (via the member's unique URL) and a satellite members-only website. Each of the satellite forums 20 offer satellite member registration means for registering a plurality of satellite-member entrepreneurs, enabling the satellite-member entrepreneurs to have access to the satellite members-only website. The multimedia tools for satellite forums 20 include ability for member entrepreneurs to build their online community to include graphics, logos, colors, content and the like to customize same with their brand information and choose their own unique URL. Primary forum 11 provides a list of all satellite forums 20 with a brief description thereof, providing the URL for each satellite forum 20, and providing a hyperlink to the satellite forum's 20 satellite-homepage. A primary search engine is provided on primary forum 11 capable of filtering information on publicly available pages of each satellite forum 20 and thus directs traffic there too, leveraging knowledge of each satellite forum 20 as well as communal knowledgebase on primary forum 11.

The primary homepage is freely accessible via the ‘E.Factor URL (trade name and domain name) and holds generic information about the system, however, one must become a member to have access to the members-only website which requires login to the closed community part of the website. The primary forum (and the satellite forums) is built as an OpenSource application to which members can build and add their own applications, parts of the site will be able to be widgetized and other new technologies have been incorporated. The ‘E.Factor has a unique structure which allows fast growth through linking other groups and offering them an off-the-shelf community/satellites forums. Each satellite forum has its own log-in and is a closed community. However, there is a link directly with the ‘E.Factor primary platform, offering satellite forum owners and their members a “window on the world” and access to all the resources of the primary forum while allowing them to customize their own satellite forums via database (Db) and content management system (CMS). Each satellite forum will have the satellite owner's own ID and look-and-feel and can therefore be tailored as needed. Members of a satellite forum can be members of the primary forum also, but member of the primary forum cannot be members of a satellite forum unless the satellite forum owner has specifically granted them access and provides them with a log-in/user ID. Thus each satellite forum is able to maintain its own character (example: a group of women entrepreneurs in the United Kingdom).

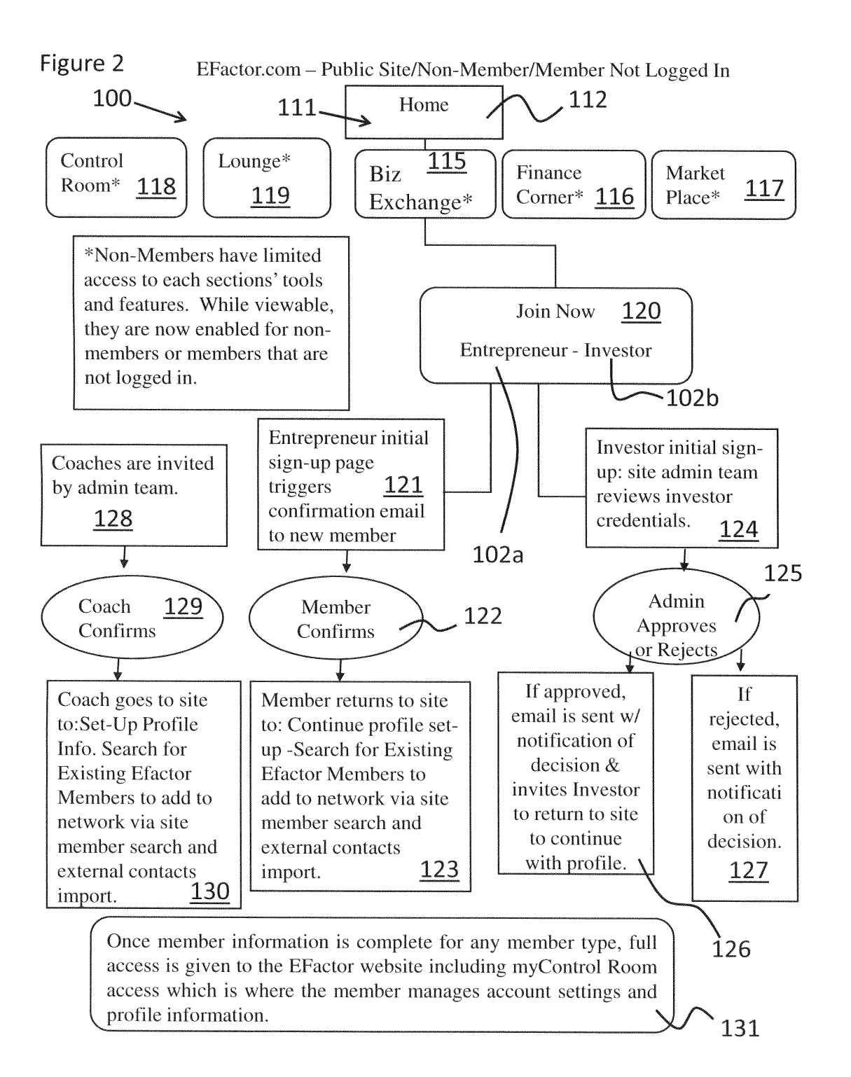

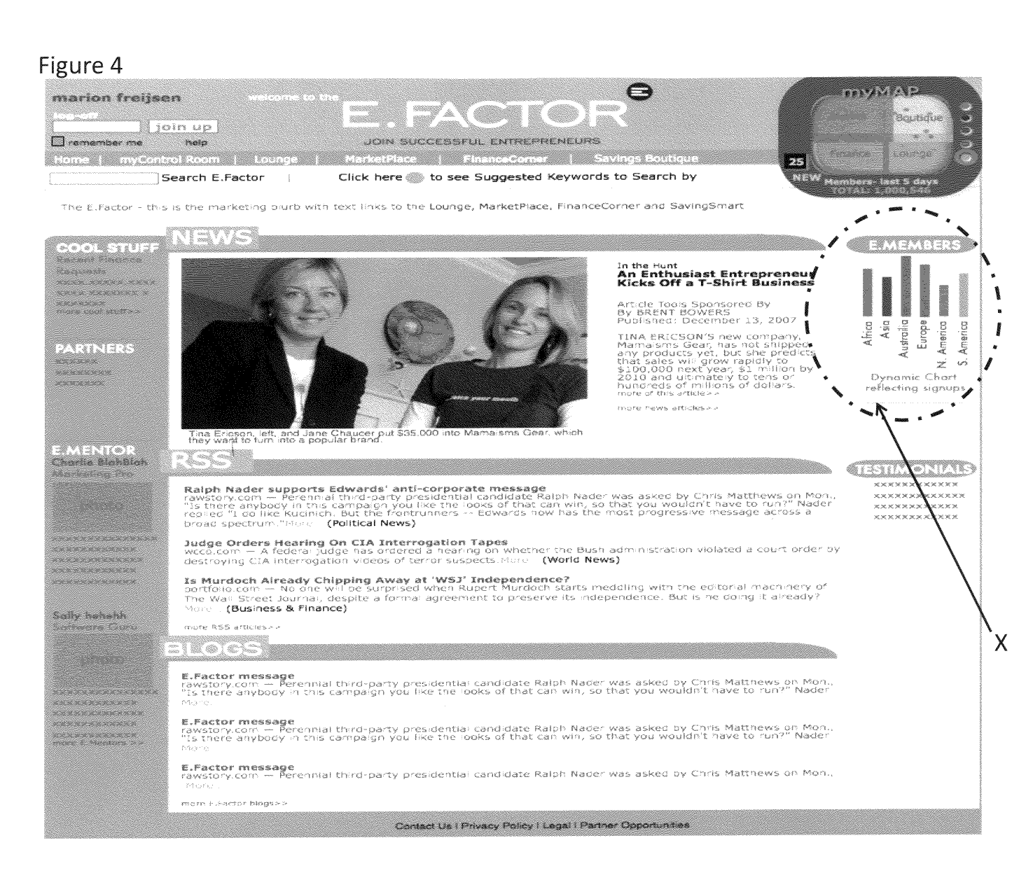

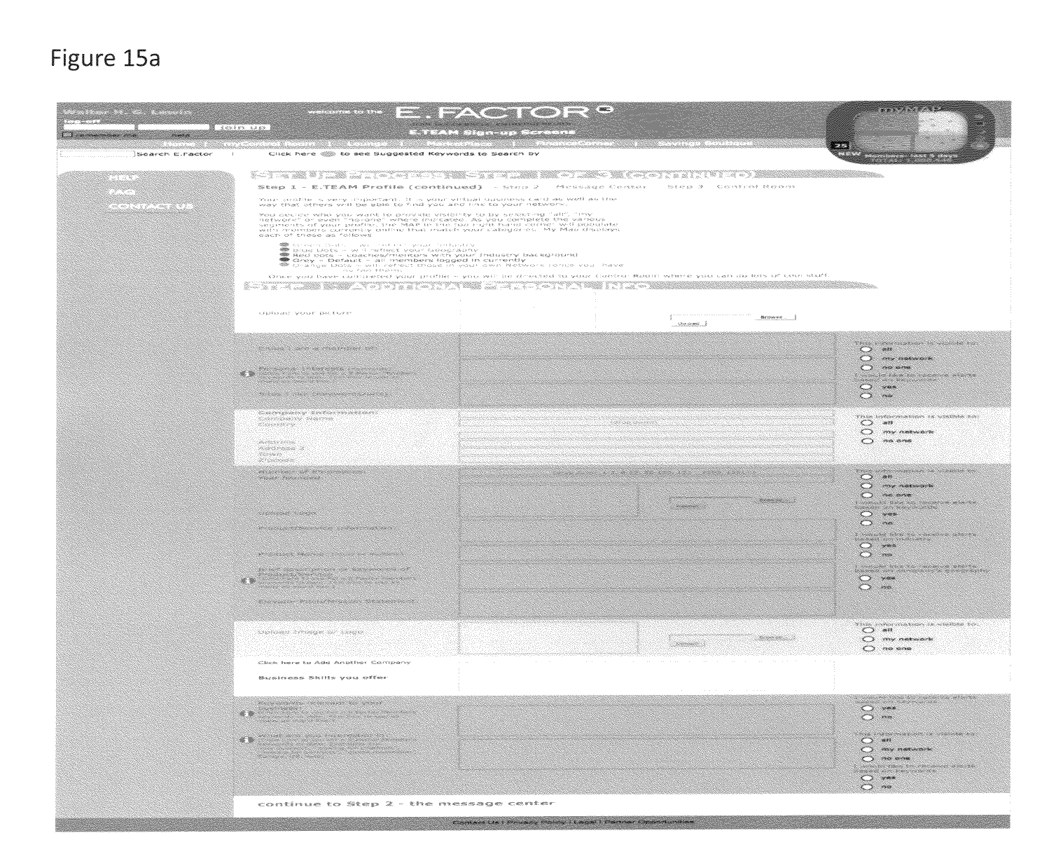

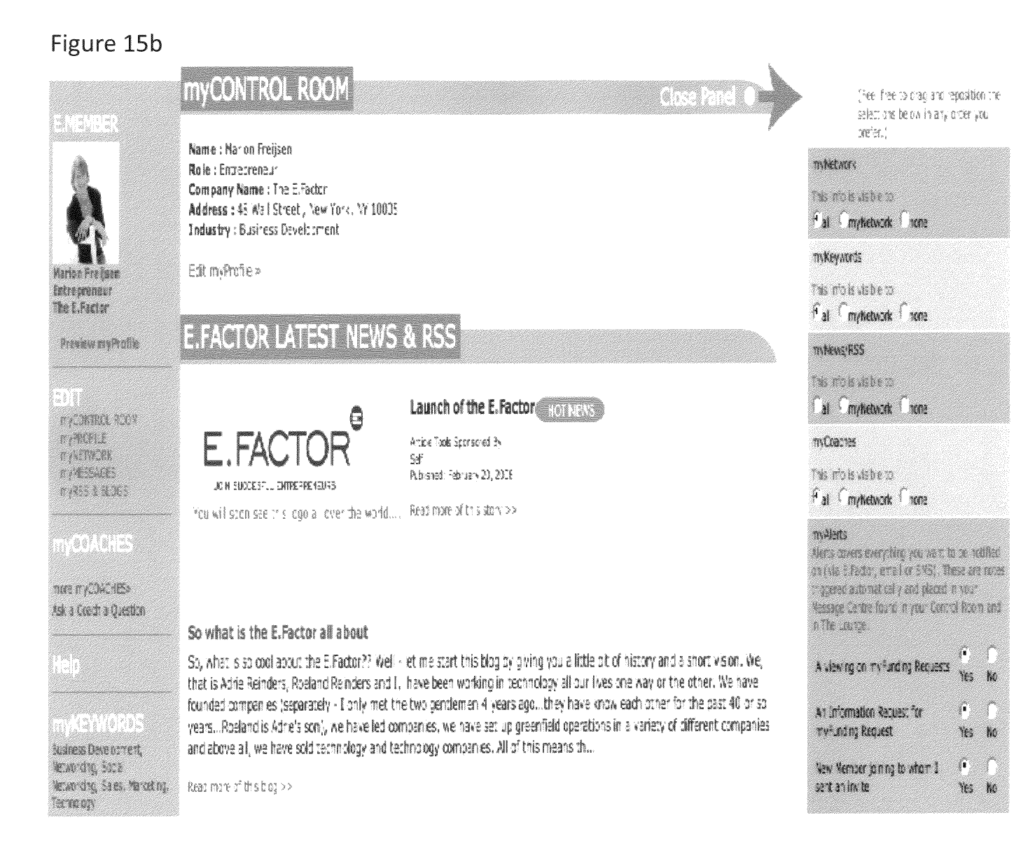

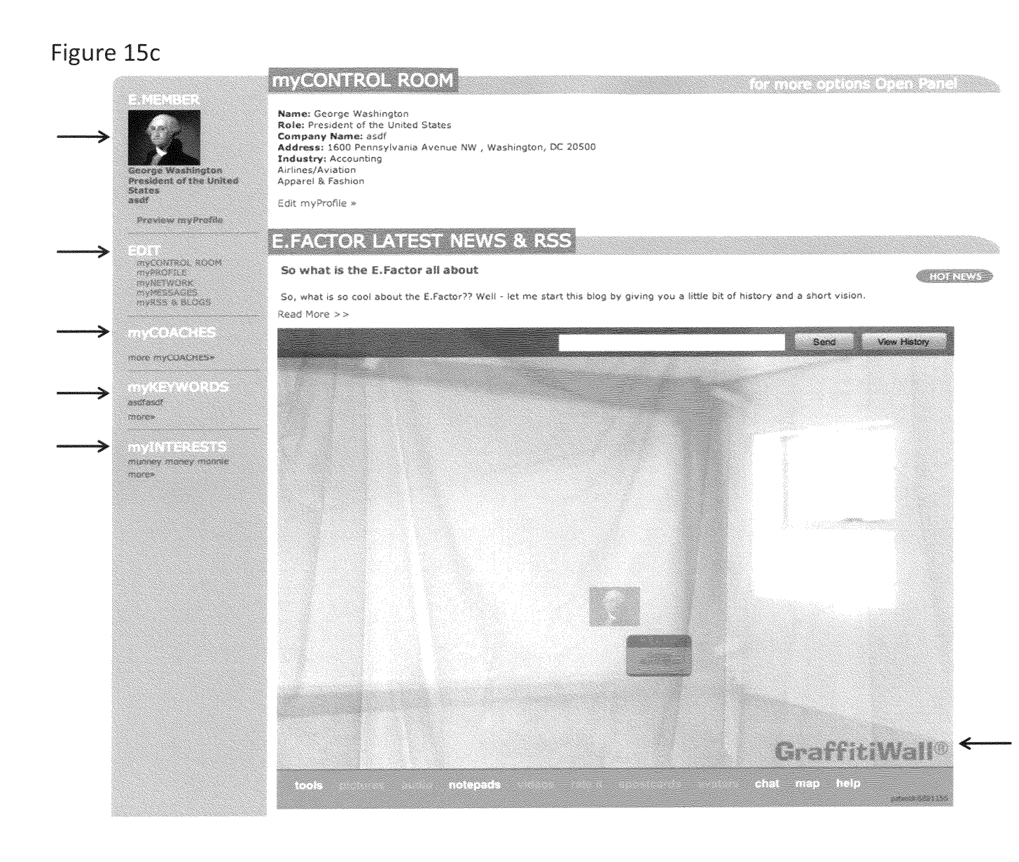

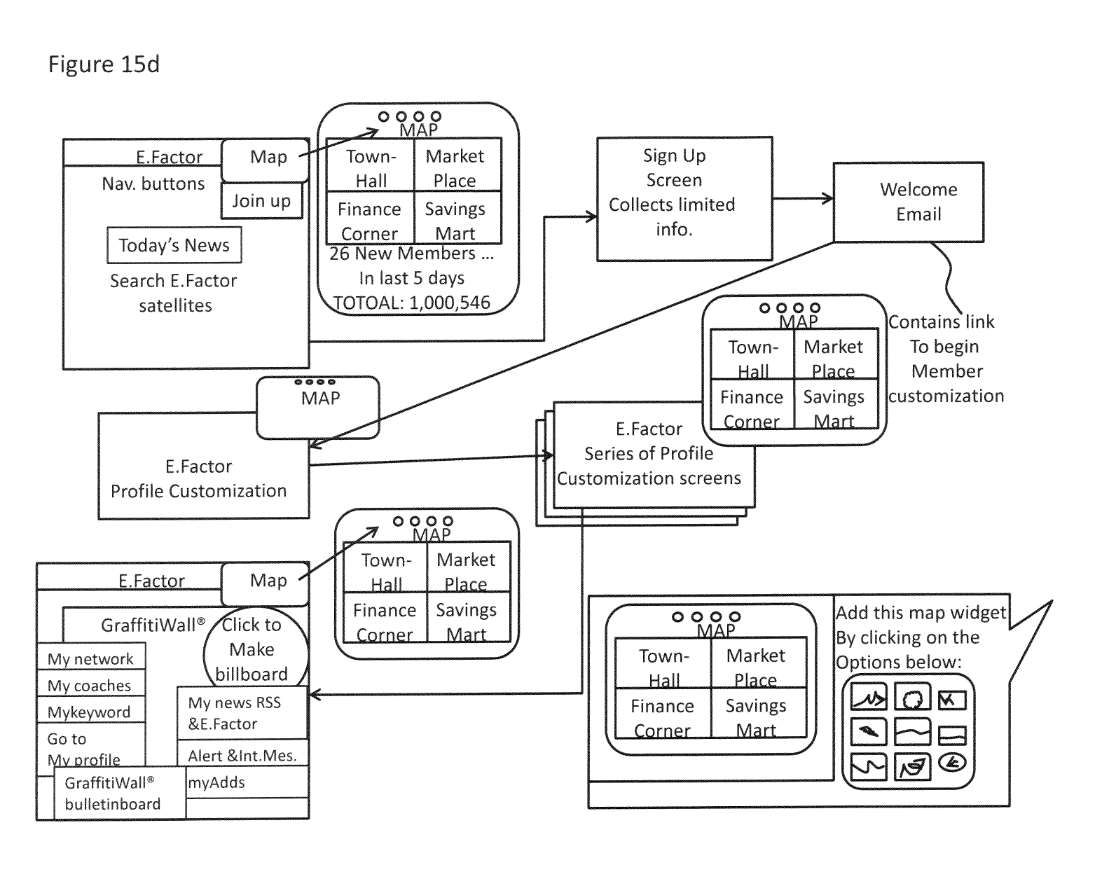

FIG. 2 is a flow chart overview showing basic operation of the platform of the entrepreneur system and method showing the collection of information, including Web pages, images, videos or other digital assets, hosted on one or several Web server(s) that is transferred to the primary forum (website) for displayed in a user's Web browser, showing Public Site/Non-Member/Member Not Logged In, shown generally at 100. Primary forum 111 consists of a homepage 112 having two parts: (i) a freely accessible homepage for members and non-members; and (ii) a members-only website. From homepage 112 access to hyperlinked content for business information, interaction and communication with each other is provided. Sample screen shots of homepage 112 of the primary forum 111 are shown in FIGS. 4 and 15. Access to hyperlinked content is provided for retrieval of business information, including a business exchange 115 (“BizExchange”), finance corner 116, and market place 117 section, as well as a control room 118 (“myControlRoom”) and lounge 119 section. Where a non-member or member not logged enters homepage 112 the user has limited access.

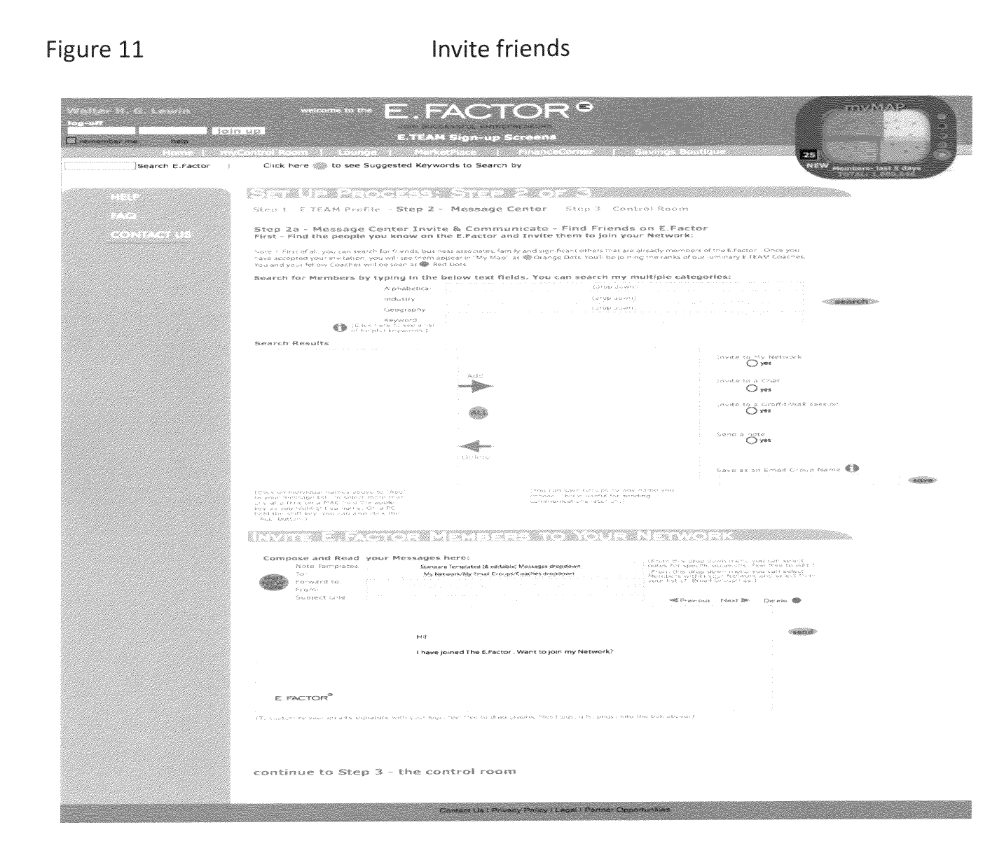

The user may select to “join now” 120 and is prompted to select whether same is joining as an entrepreneur member 120a or an investor member 120b. Where the user is joining as an entrepreneur member 120 the user is diverted to an entrepreneur initial sign-up page and same triggers a confirmation email to the new member 121. Upon confirmation of the email, the user (now member) confirms same 122, and the user, now member, returns to the homepage 112 to continue the profile set-up, search for existing members to add to his/her network via site member search and external contacts import 123. Using the profile bare minimum tool FIG. 13a or profile full tool of FIG. 13b. (see FIG. 11 is a sample Invite Friends screen shot). Where the user is an investor 120b, the investor signs-up via an initial sign-up page, and an email is sent to the site administration team to review the investor credentials 124. From there, the administration team either approves or rejects the investor's membership 125. If approved, an email is sent with notification of the approval and the investor is invited back to the homepage 112 to continue with his/her profile creation 126. Using the profile bare minimum tool FIG. 13a or profile full tool of FIG. 13b. If the investor's membership request is rejected, an email is sent with notification of the rejection 127.

Coaches, or “expert entrepreneurs” or consultant level entrepreneurs, are invited by the administration team to joint as coach members 128. Coach members are selected from a group of successful entrepreneurs and invited to join the network through a network administrator. The coach elects whether he/she is interested in being a coach member, confirming the invitation if electing to become a member 129. Upon electing to become a member, the coach goes to the homepage 112 and inputs profile information, and can search for existing members to add to his/her network via site member search and external contacts import 130. Using the profile bare minimum tool FIG. 13a or profile full tool of FIG. 13b. A coach search hyperlink allowing members to search for coach members and ask advice and get expert tailored responses from at least one of the coach members is provided. Once member information is complete for the entrepreneur, investor and coach members, full access is given to the primary forum (main website), including myControl Room 118 access, which is where members manage account settings and profile information 131.

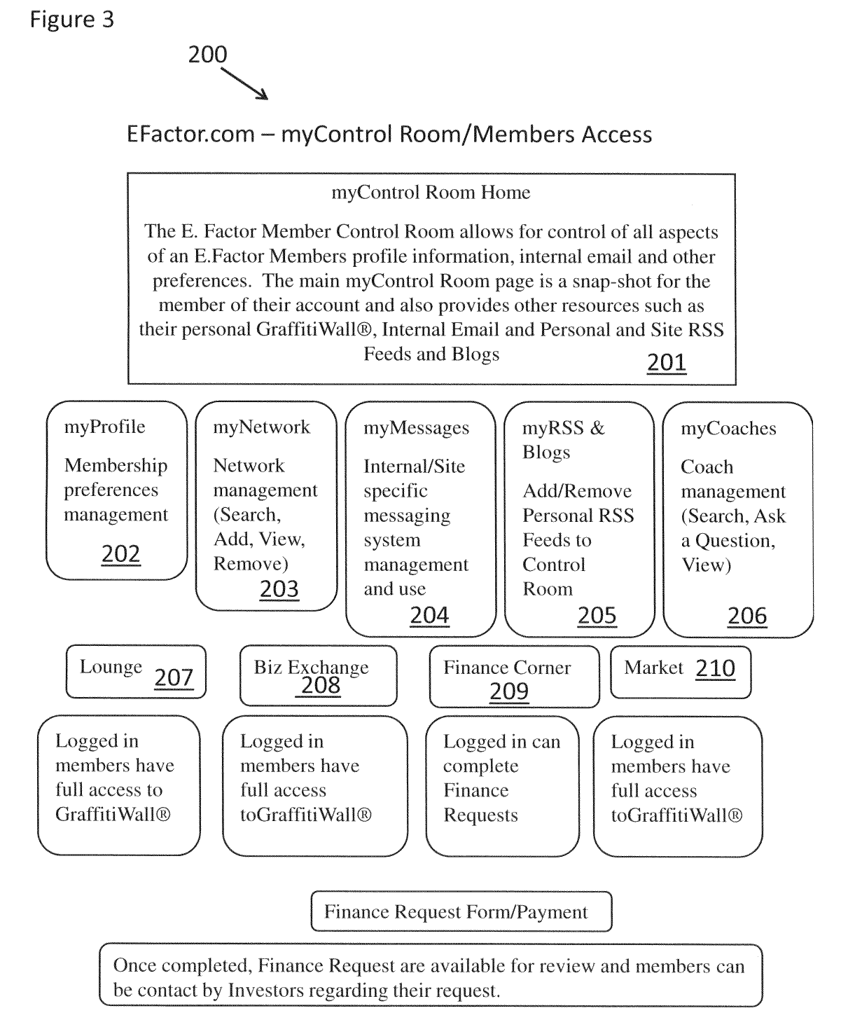

FIG. 3 is a flow chart overview showing basic operation of the platform of the entrepreneur system and method showing member access to myControl Room, shown generally at 200. The member control room allows for control of all aspects of a member's profile information, internal email and other preferences. The main myControl Room page 201 is a snap-shot for the member of their account and also provides other resources, such as a personal multimedia wall (such as that sold under the trade name GraffitiWall™), internal email and personal and site RSS feeds and blogs. A screen shot of myControl Room is shown in FIGS. 12a and 12b. MyControl Room 201 provides members with links for profile input 202, listing membership preferences and management information, network management 203, messages 204, RSS and Blogs 205 and myCoaches 206. MyNetwork 203 provides management of the member's network/contact and allows the member to search for, add, remove or view contacts. MyMessages 204 provides an internal site specific messaging system. MyRss and blogs 205 allows members to add/remove personal RSS (Really Simple Syndication) feeds to control room 118 (FIG. 2). MyCoaches 206 provides management of the members coaches, and allows members to search for coaches and ask questions and view answers. Logged in members have full access to the multimedia walls on the primary forum, having access to the multimedia wall of the lounge 207, biz exchange 208, and market place 210, and having ability to complete finance requests on the finance corner 209.

FIG. 4a is a sample introductory home page screen shot, showing the hyperlinks to internal information on the primary forum, including raising funding 303, customer relations 301, and getting advice from top experts (coaches) 302. FIG. 4b is blow-up of an example of the dynamic chart reflecting global memberships taken in section X located on the introductory home page screen shot of FIG. 4a. The live dynamic chart 500 reflects the global memberships, shown with the nation/geographical region listed 501 (i.e. Africa, Asia, Australia, Europe, N. America, S. America) and a bar graph 502 indicating membership in the given region 501. Preferably, each region 501 is indicated in a given color, and each bar graph 502 is shown in the same color for readily discerning memberships.

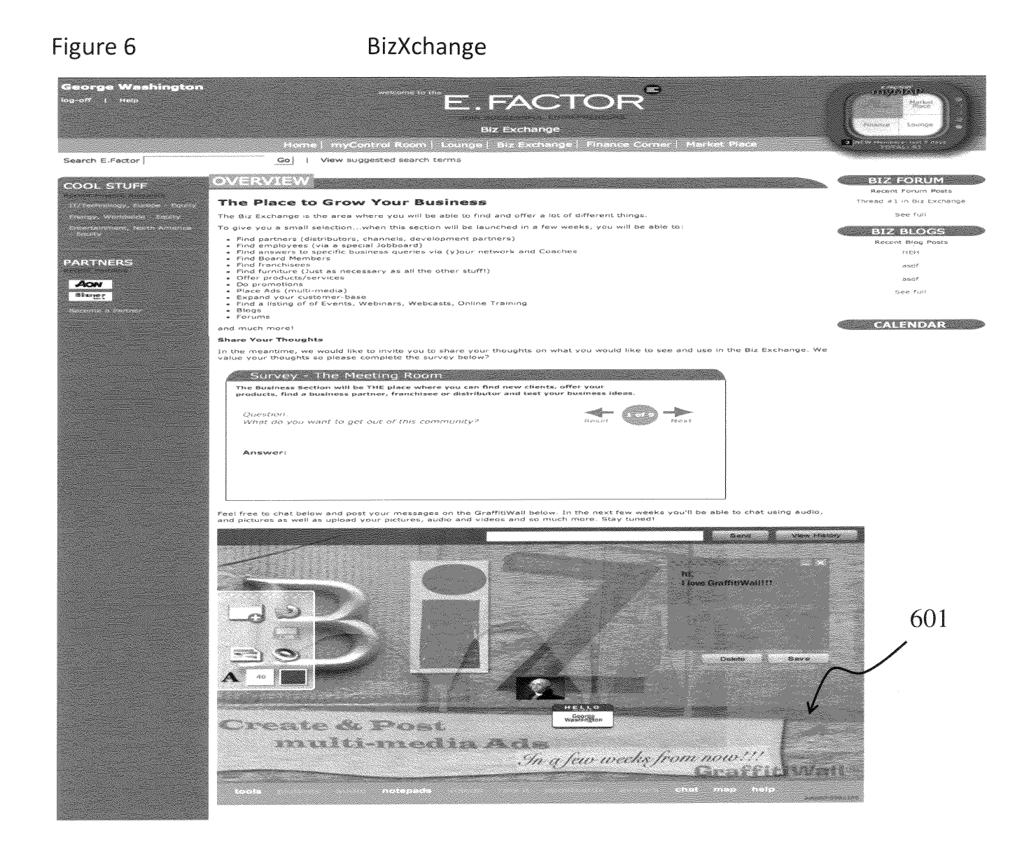

The hyperlinked content of the primary forum preferably includes a [my]control room, lounge, business exchange, finance corner and market place sections each having multimedia tools and features, wherein non-members have limited access to each of the section's tools and features. A screen shot of the business exchange section is shown in FIG. 6. The business exchange section assists members in finding: (i) partners, distributors, channels of trade, and development partners; (ii) employees through a special job board link; (iii) answer to specific business queries via the primary forum, satellite forums and/coaches; (iv) board members; (v) franchises; (vi) furniture; and (vii) listings of events, webinars, webcasts, and online training. The business exchange section assists members in offering multimedia products/services, conducting promotions, placing multi-media ads, expanding customer base, and accessing blogs and forums. A multi media wall 601 is provided (such as sold by ColorLightAndShadow under the trade name GraffitiWall®).

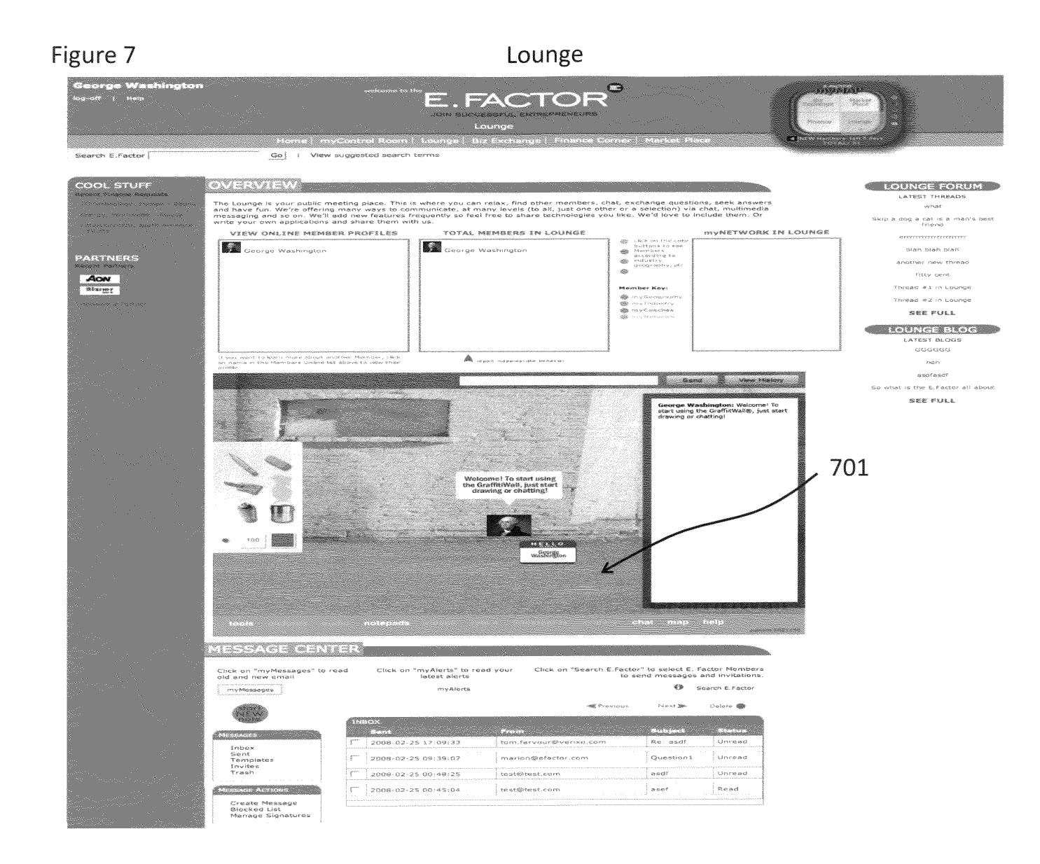

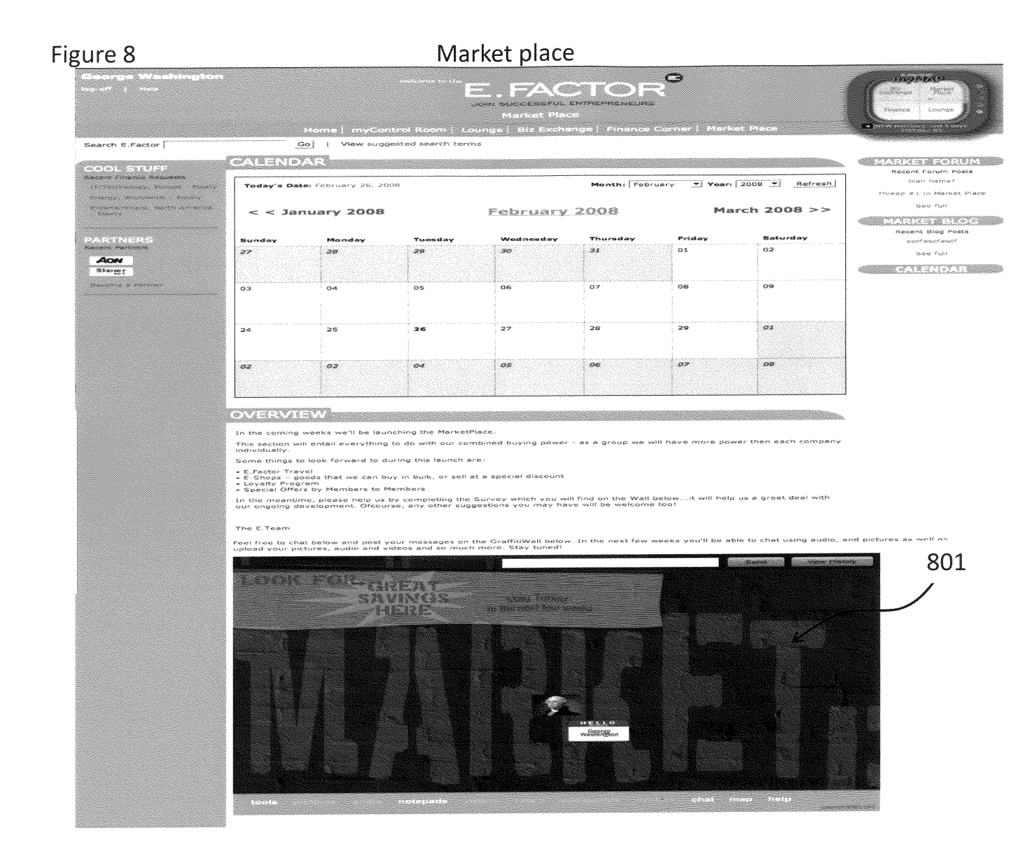

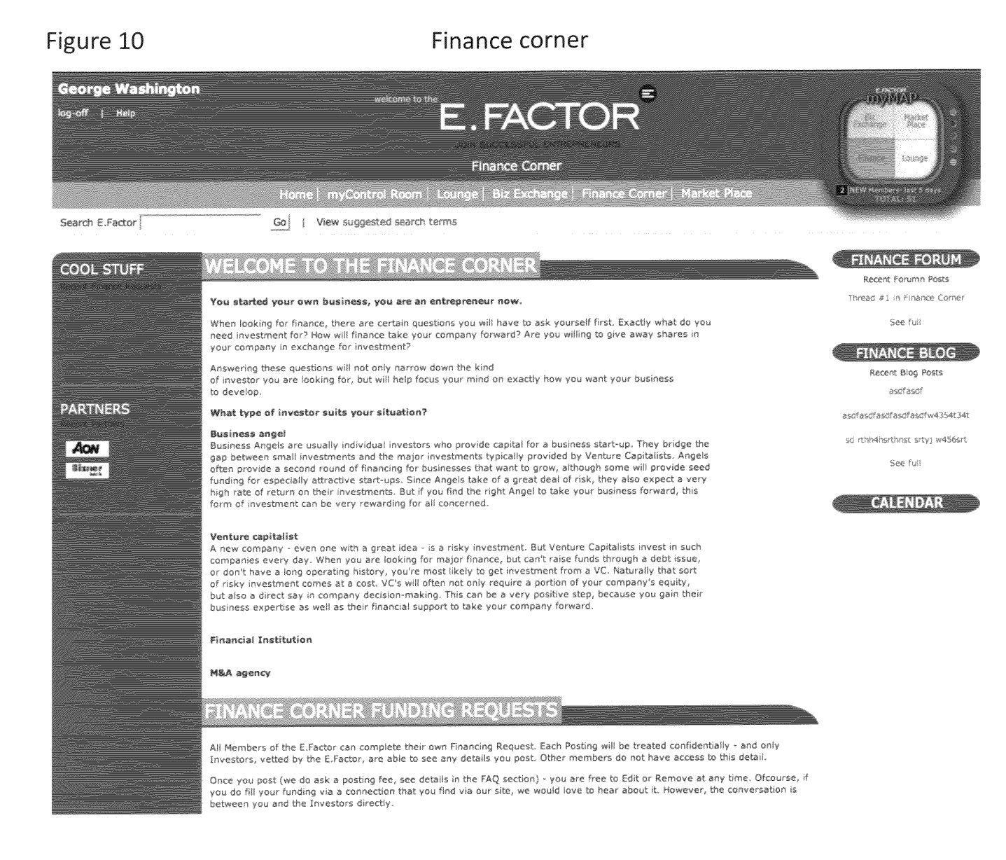

A screen shot of the lounge section is shown in FIG. 7. The lounge section is a public multimedia meeting place where members can relax, find other members, see current members recent requests such as finance requests, chat, exchange questions, seek answers and socialize through chat and a plethora of multimedia messaging tools and graphics. A multi media wall 701 is provided (such as sold under the trade name GraffitiWall®). A screen shot of the market place section is shown in FIG. 8. The market place section is a multimedia public meeting place where members can combine buying or selling power, including in travel, goods, service, loyalty programs, and list special offers from members for members and socialize through chat and a plethora of multimedia messaging tools and graphics. A multi media wall 801 is provided (such as sold under the trade name GraffitiWall®). A screen shot of the finance corner section is shown in FIG. 10. Using the finance corner section, a member has access to a multimedia public meeting place where they can find information on types of investors, including business angels, venture capitalists, financial institutions, and merger and acquisition agencies, and post financing request only viewable by the investor members. A screen shot of the [my]control room section is shown in FIGS. 12a and 12b, with FIG. 12a showing a sample screen shot of the My Control Room tools and FIG. 12b showing a sample screen shot of the My Control Room extended with design on multimedia walls 1201a and 1201b, respectively. [My]control room section is a multimedia meeting place where members can control all aspect of their profile information, internal email and other preferences, providing latest news, and having subsections including myNetwork 1202a, 1202b (listing said member's community or member contacts) and myMessage Center 1203a, 1203b (listing messages posted to said member). Preferably, the mycontrol room, lounge, business exchange, and market place sections each include a multimedia wall (such as sold under the trade name GraffitiWall®) for discussions, messaging, chats and name branding tools and features, including avatars.

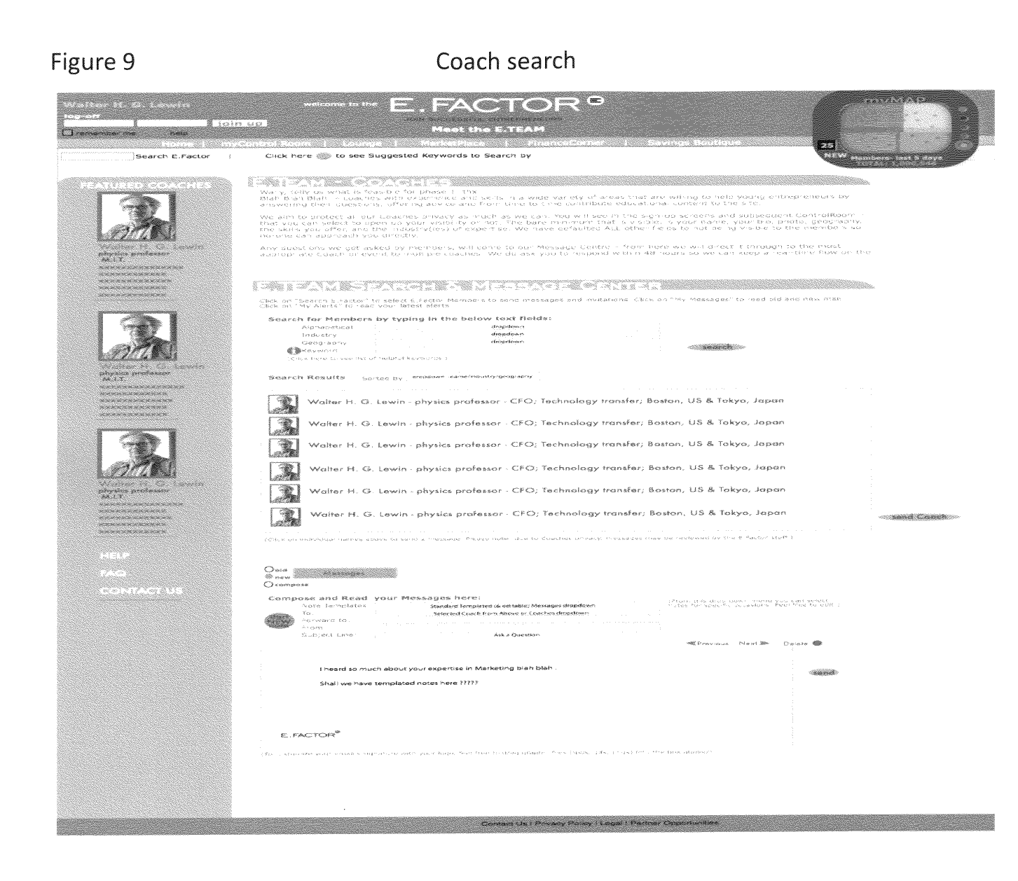

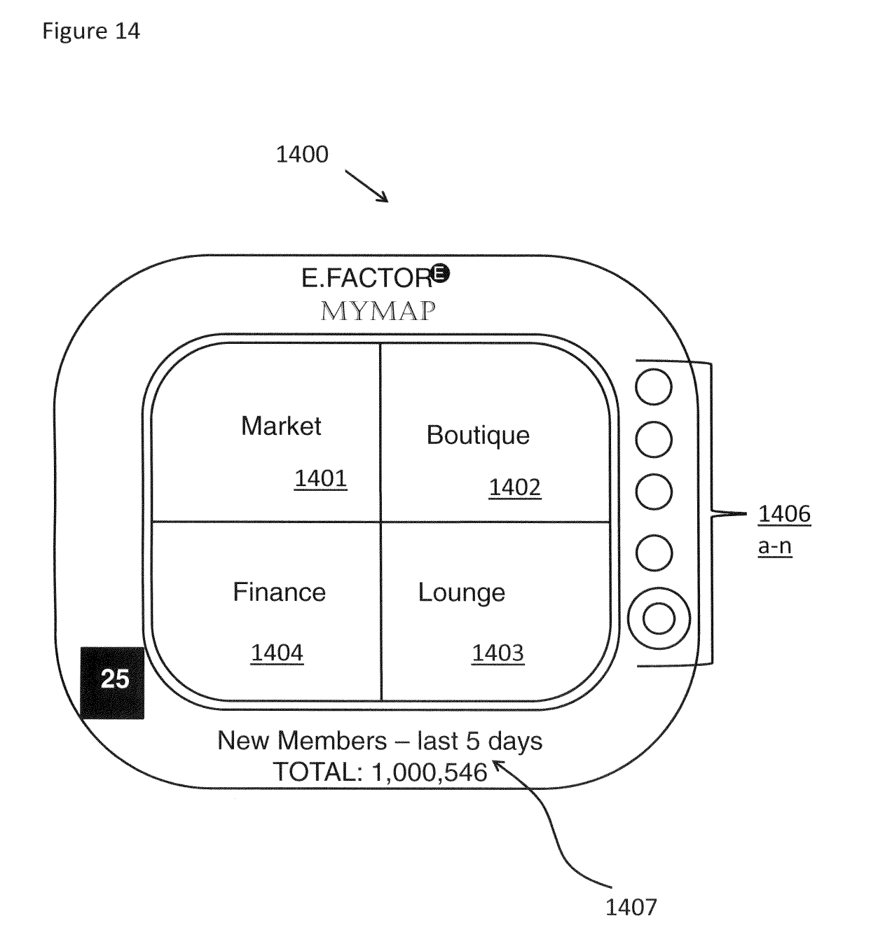

FIG. 14 shows the navigational tool, shown generally at 1400. Preferably, the system comprises navigational tool 1400, which includes at least four distinct quadrants linked to business exchange 1402, market place 1401, finance 1404, and lounge sections 1403 of the primary forum. The navigation tool is prominently displayed on all pages navigated to on the primary forum, notice same is located on screen snap shots for FIGS. 6-13. The navigation tool is provided as a widget so it can be loaded into the satellite forums and utilized to immediately jump to the primary forum. Each of quadrant 1401-1404 is shown as a section specified color, or color coded throughout the system, and displayed for easy recognition. A frame 1405 extends around quadrants 1401-1404. Frame 1405 includes a plurality of colored dots 1406a-n. Each of the colored dots 1406a-n represents information as to other members currently online. Each of the members are displayed in different colors (1406a, 1406b, . . . etc.) indicating whether they match a viewing member's network, geography, industry, or are one of the viewing members coaches. Clicking on each respective dot 1406a-n displays the profile of the member associated with the dot1406a-n. When hovering over a quadrant, it provides selections, including: go to finance corner now; go to market place now; go to lounge now; or go to market place now. When hovering over one of the color buttons (1406) it provides selections: over the orange button it reads “see members in your network”; over the red button it reads “see coaches in your industry”; over the green button it reads “see members in your industry”; over the blue button it reads “see members in your geography”; and over the grey button it reads “see all members currently online”. Wherein, the color code may be provided as (for button 1406): grey indicates members now online; blue indicates members within the user member's geography online; green indicates members within the user member's industry; red indicates the user member's coaches; and orange indicates the user member's network now online.

FIGS. 15a and 15b are screen shots showing the sign up process/set up process step that is provided for each member upon registration. Specifically, FIG. 15a is a screen shot showing the sign up process/set up process step leading to Control Room; and FIG. 15b is a half screen shot from a panel within Control Room, showing privacy settings. Profile pages are personal pages where personal and business related data of each member is visible for other members. Profile pages are the basis for the social network and can be visited and viewed by all members. Members can add content to their own personal profile page. Members fill in their personal information, professional information and their interests, serving as a valuable networking tool. Each member can choose which information is displayed to whom, differentiating between “nobody”, their own contacts and “everybody”. Based on the profiles people can search for similar people. This can be done based on a variety of aspects ranging from name, company, industry to interests. Once they have found a like-minded person they can then invite him/her to their own network. People have various ways to contact each other, for instance via internal messaging and skype. After registering and logging onto the system, the member has access to a variety of links, including, for example, a forum. Forum/lounge allows a space for discussions to take place. Members reply on topics raised by the editor(s) or create discussion topics of their own. The platform is set up in such a way that new modules and functionalities can be added. These functionalities will then also be available for the satellite forums which are connected to the ‘E.Factor. FIG. 15c is a screen shot showing [my]ControlRoom upon signing on and FIG. 15d is a flow chart showing sign-up steps. After logging in, members can enlarge their map to see other member by clicking on one of the map's legion colors (map shown in FIG. 14). Members can widgetize their map and most of their control room items into other web sites (i.e. into the satellite websites/forums). Non-members can view home page offerings and the four quadrant offerings of the map but cannot fully participate. There are three types of sign up: standard, late, for use at trade shows and possibly within partner sites, and coach which is by invitation only. As well as an investor sign-up, subject to administrative review. Within this phase (sign up) members can import names and addresses from their email address books as well as their social networking memberships (i.e. those social networks used under the trademarks Facebook®, MySpace®, etc). Within the profile customization stage, members can customize and order the following content areas on their dashboard: my Network; My News and RSS feeds; My Finance Requests; My Ads; My Keywords; My Profile; My coaches; and alerts and messaging. Members can widgetize my map, my network, my news, my profile, alerts, and my ads.

There is a wealth of content for entrepreneurs, apart from the member generated content (i.e. forum discussions, profile pages, weblogs). A plethora of generic content, such as articles, reviews, research papers, links etc. can be added by assigned editors via an easy to use Content Management System. The ‘E.Factor Satellite offers a unique, off-the-shelf package to build a closed community for each member's organization, company, club, etc. The satellite site runs on the ‘E.Factor platform. Because of the ‘E.Factor Satellite, one can enjoy the benefits of a closed community with extensive functionality without going through an elaborate technology building process independently. Each satellite is connected to the ‘E.Factor but at all times retains its own identity. Its design is based on each individual member's corporate identity and own URL. Being linked to ‘E.Factor means that it's very easy for members to subscribe to the ‘E.Factor and thus benefit from a host of additional functionality and knowledge beyond the satellite sites own offering, as well as providing ‘E.Factor members exposure to other member's site. Like the ‘E.Factor main site, each satellite consist of two parts: (i) a freely accessible homepage (the member's URL); and (ii) a members-only website. The freely accessible home page is directly available and accessible for everyone via each individual member's own URL, and holds generic information about each member's community. It's also the page via which each member's own members will login to access the closed community part of the website. Once people have subscribed they can login to the members-only part of another member's community with their e-mail address/user name and password.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A social networking system for entrepreneurs, comprising:
a. a primary forum offering a plurality of multimedia tools and a primary member registration means for registering a plurality of members for access within a primary community, said members comprising entrepreneur members, investor members and coach members, said primary forum enabling said members to access hyperlinked content for business information and interact and communicate with each other;
b. a plurality of satellite forums with unique URLs being linked to, hosted and maintained by said primary forum and including said multimedia tools derived from said primary forum, wherein said satellite forums act as meeting places for satellite groups and satellite communities, and wherein said multimedia tools derived from said primary forum are capable of being custom tailored to reflect said group's unique character.

2. A system as recited by claim 1, wherein said primary registration means comprises profile data including business related data, personal interest data, and access preferences, wherein said profile data is accessible to different members based on each member's own access preferences.

3. A system as recited by claim 1, wherein each of said satellite forums comprise a freely accessible satellite-homepage (via said member's said unique URL) and a satellite members-only website.

4. A system as recited by claim 3, wherein each of said satellite forums include satellite member registration means for registering a plurality of group members access within a satellite community for social networking within said group and allow said group to maintain its own closed community, offering content for its members only.

5. A system as recited by claim 1, wherein said multimedia tools for said satellite forums include ability for said satellite groups to build their online community to include graphics, logos, colors, content and the like to customize same with their brand information.

6. A system as recited by claim 1, wherein said primary forum provides a list of all satellite forums with a brief description thereof, providing said URL for each satellite forum, and providing a hyperlink to said satellite forum's satellite-homepage.

7. A system as recited by claim 1 comprising a primary search engine on said primary forum capable of filtering information on publicly available pages of each satellite forum and thus directs traffic there too, leveraging knowledge of each satellite forum as well as communal knowledgebase on said primary forum.

8. A system as recited by claim 1, wherein said hyperlinked content of said primary forum includes a mycontrol room, lounge, business exchange, finance corner and market place sections each having multimedia tools and features, wherein non-members have limited access to each of said section's tools and features.

9. A system as recited by claim 8, wherein said business exchange section assists members in finding: (i) partners, distributors, channels of trade, and development partners; (ii) employees through a special job board link; (iii) answer to specific business queries via said primary forum, satellite forums and/said coaches; (iv) board members; (v) franchises; (vi) furniture; and (vii) listings of events, webinars, webcasts, and online training.

10. A system as recited by claim 8, wherein said business exchange section assists members in offering multimedia products/services, conducting promotions, placing multi-media ads, expanding customer base, and accessing blogs and forums.

11. A system as recited by claim 8, wherein said lounge section is a public multimedia meeting place where members can relax, find other members, see current members recent requests such as finance requests, chat, exchange questions, seek answers and socialize through chat and a plethora of multimedia messaging tools and graphics.

12. A system as recited by claim 8, wherein said market place section is a multimedia public meeting place where members can combine buying or selling power, including in travel, goods, loyalty programs, and list special offers from members for members and socialize through chat and a plethora of multimedia messaging tools and graphics.

13. A system as recited by claim 8, wherein said finance corner section is a multimedia public meeting place where members can find information on types of investors, including business angels, venture capitalists, financial institutions, and merger and acquisition agencies, and post financing request only viewable by said investor members.

14. A system as recited by claim 8, wherein said mycontrol room section is a multimedia meeting place where members can control all aspect of their profile information, internal email and other preferences, providing latest news, and having subsections including myNetwork (listing said member's community or member contacts) and myMessage Center (listing messages posted to said member).

15. A system as recited by claim 8, wherein said mycontrol room, lounge, business exchange, and market place sections each include a multimedia wall for discussions, messaging, chats and name branding tools and features.

16. A system as recited by claim 1, wherein said coach members are selected from a group of successful entrepreneurs and invited to join said network through a network administrator.

17. A system as recited by claim 1, wherein said investor members are selected and approved by said network through a network administrator.

18. A system as recited by claim 1 comprising a live dynamic chart reflecting global memberships.

19. A system as recited by claim 8 comprising a navigational tool comprising at least four distinct quadrants linked to said business exchange, market place, finance, and lounge sections, that is prominently displayed on all pages navigated to on said primary forum, wherein said navigation tool is provided as a widget so it can be loaded into said satellite forums and utilized to immediately jump to said primary forum.

20. A system as recited by claim 19, wherein each of said quadrants is shown as a section specified color displayed for easy recognition.

21. A system as recited by claim 19 comprising a frame including a plurality of colored dots, each of said colored dots representing information as to other members currently online, wherein each of said members are displayed in different colors indicating whether they match a viewing member's network, geography, industry, or are one of said viewing members coaches, wherein clicking on said dot displays said profile of said member associated with said dot.

22. A system as recited by claim 1 comprising a coach search hyperlink allowing said members to search for said coach members and ask advice and get expert tailored responses from at least one of said coach members.

23. A system as recited by claim 1 comprising a messaging feature wherein said members can have alerts and messages sent to their mobile phone.

24. A method for displaying business information to a plurality of entrepreneurs in a networked interactive system, comprising the steps of:
a. structuring a platform with a primary forum offering a plurality of multimedia tools and a primary member registration means for registering a plurality of members for access within a primary community, said members comprising entrepreneur members, investor members and coach members, said primary forum enabling said members to access hyperlinked content for business information and interact and communicate with each other;
b. further structuring said platform with a plurality of satellite forums with unique URLs being linked to, hosted and maintained by said primary forum and including said multimedia tools derived from said primary forum, wherein said satellite forums act as meeting places for satellite groups and satellite communities, and wherein said multimedia tools derived from said primary forum are capable of being custom tailored to reflect said group's unique character.

25. A method as recited by claim 24 comprising a chat feature wherein said members can communicate real time.

26. A social networking system for entrepreneurs, comprising:
a. a primary forum offering a plurality of multimedia tools and a primary member registration means for registering a plurality of members for access within a primary community, said members comprising entrepreneur members, investor members and coach members, said primary forum enabling said members to access hyperlinked content for business information and interact and communicate with each other; and
b. a navigational tool comprising distinct quadrants linked to a plurality of content sections, that is prominently displayed on all pages navigated to within said primary forum, wherein said navigation tool is provided as a widget so it can be loaded into satellite forums and hyperlinked to said primary forum so that it can be utilized to immediately jump to said primary forum from said satellite forums.
